(19) United States
(12) Patent Application Publication
(10) Pub. No.: US 2014/0289735 A1
(43) Pub. Date: Sep. 25, 2014

(54) CAPACITY MANAGEMENT SUPPORT APPARATUS, CAPACITY MANAGEMENT METHOD AND PROGRAM

(71) Applicant: Ryosuke Togawa, Tokyo (JP)

(72) Inventor: Ryosuke Togawa, Tokyo (JP)

(73) Assignee: NEC CORPORATION, Tokyo (JP)

(21) Appl. No.: 14/002,679

(22) PCT Filed: Jan. 17, 2013
(86) PCT No.: PCT/JP2013/000188

§ 371 Date: Aug. 30, 2013

(30) Foreign Application Priority Data
Mar. 2, 2012 (JP) 2012-047305

(51) Int. Cl. G06F 9/50

(52) U.S. Cl. CPC G06F 9/5083
USPC 718/104

(57) ABSTRACT

A log acquisition unit (106) determines log types to be extracted from logs of a monitoring target system, on the basis of a type definition (112) and input information acquired by an input unit (104), thereby creating first log data. A log distribution estimation unit (108) estimates a distribution density function, which indicates actual distribution, in second log data which is extracted on the basis of the type definition (112) and the first log data. The log distribution estimation unit (108) selects a range, which satisfies a specific condition, in the distribution density function, thereby creating third log data from the second log data. A resource usage rate prediction unit (110) calculates predicted values of resource usage rates from a load definition (114) and a prediction expression of the resource usages calculated on the basis of the third log data of a certain threshold value or more.

### TECHNICAL FIELD

The present invention relates to an apparatus for managing a system capacity, a method of managing the system capacity, and a program therefor.

### BACKGROUND ART

The utilization form of the computer system, which is called cloud computing such as Infrastructure as a Service (IaaS) or Software as a Service (SaaS) has begun to spread widely. Accordingly, more and more users prefer the flexible operation of the system such as dynamically changing the system structure on demand.

Further, in the case of dynamically changing a computer resource such as a Central Processing Unit (CPU) or a storage device constituting a system, it is necessary for a system provider to guarantee performance, which is required by a user, to be achieved by the system after the change. Accordingly, the system provider needs to perform capacity management for predicting whether the system has a sufficient processing capacity relative to an expected load. For example, it is necessary for the system provider to know information such as which level of a specification is needed for a CPU or a memory relative to an assumed load or by how much the level of the current specification is insufficient for processing of the assumed load.

Patent Document 1 discloses an example of the capacity prediction system.

For example, in the capacity prediction system of Patent Document 1, first, logs of transactions and resource usages are acquired from a computer, and a resource usage rate is calculated by using multiple regression analysis for each transaction. Next, on the basis of the logs of the transactions, a prospective throughput is predicted for each transaction. On the basis of the resource usage rates and the throughputs, the transitions of the resource usage rates of the computer are predicted.

### RELATED DOCUMENT

### Patent Document

[Patent Document 1] Japanese Patent No. 4756675

### DISCLOSURE OF THE INVENTION

In the capacity management, in order to analyze how much resource is required to be secured to process the load, the logs of the loads and the logs of the resource usages, which were recorded in the monitoring target system in the past, are used. For example, on the basis of the logs, relationships between the loads and the resource usages are derived, whereby it is possible to calculate an amount of resources capable of processing the assumed loads.

However, when the relationships between the loads and the resource usages are derived on the basis of the logs, due to loss in the measured logs, errors based on characteristics of the middleware for measuring the logs, or the like, the distribution of the measured logs is not always likely to coincide with the actual distribution based on the relationships between the loads and the resource usages.

The capacity prediction system of Patent Document 1 derives the relationships between the transactions and resource usages by directly using the logs acquired from the computer. Hence, the loss or errors in the logs may cause errors in deriving the relationships between the transactions and resource usages.

An object of the present invention is to provide a capacity management support apparatus, a capacity management method, and a capacity management program for calculating highly accurate predicted values when predicting the relationships between the loads and the resource usages.

According to an aspect of the present invention, there is provided a capacity management support apparatus including:

storage unit that stores a type definition, which associates logs for resources with logs for loads corresponding to the logs for the resources, and a load definition which defines assumed load values as values of the loads that are assumed for a monitoring target system;

input unit that acquires input information which specifies association between the logs for the resources and the logs for the loads from among the type definition;

log acquisition unit that determines log types to be acquired on the basis of the input information and the type definition, and acquires first log data which is obtained by extracting data on the determined log type from the logs held by the monitoring target system;

log distribution estimation unit that acquires second log data, which is data of correspondence relationships between the specific resources and the specific loads extracted from the first log data, on the basis of the type definition, estimates a distribution density function, which indicates actual distribution of load values and resource usages, on the basis of the second log data, selects a range, which satisfies a specific condition, from the distribution density function, and acquires third log data, which is data belonging to the range, in the second log data; and

resource usage rate prediction unit that calculates a prediction expression for resource usage rates on the basis of data of a certain threshold value or more in the third log data, and calculates predicted values of the resource usage rates, on the basis of the prediction expression and the load definition.

According to another aspect of the present invention, there is provided a capacity management method performed by a computer, including:

reading a type definition, which associates logs for resources with logs for loads corresponding to the logs for the resources, and a load definition, which defines assumed load values as values of the loads that are assumed for a monitoring target system, from storage unit;

acquiring input information which specifies association between the logs for the resources and the logs for the loads from among the type definition;

determining log types to be acquired on the basis of the input information and the type definition, and acquiring first log data which is obtained by extracting data on the determined log type from the logs held by the monitoring target system;

acquiring second log data, which is data of correspondence relationships between the specific resources and the specific loads extracted from the first log data, on the basis of the type definition, estimating a distribution density function, which indicates actual distribution of load values and resource usages, on the basis of the second log data, selecting a range, which satisfies a specific condition, from the distribution density function, and acquiring third log data, which is data belonging to the range, in the second log data; and

calculating a prediction expression for resource usage rates on the basis of data of a certain threshold value or more in the third log data, and calculating predicted values of the resource usage rates, on the basis of the prediction expression and the load definition.

According to still another aspect of the present invention, there is provided a program for causing a computer to execute functions of:

storing a type definition, which associates logs for resources with logs for loads corresponding to the logs for the resources, and a load definition which defines assumed load values as values of the loads that are assumed for a monitoring target system;

acquiring input information which specifies association between the logs for the resources and the logs for the loads from among the type definition;

determining log types to be acquired on the basis of the input information and the type definition, and acquiring first log data which is obtained by extracting data on the determined log type from the logs held by the monitoring target system;

acquiring second log data, which is data of correspondence relationships between the specific resources and the specific loads extracted from the first log data, on the basis of the type definition, estimating a distribution density function, which indicates actual distribution of load values and resource usages, on the basis of the second log data, selecting a range, which satisfies a specific condition, from the distribution density function, and acquiring third log data, which is data belonging to the range, in the second log data; and

calculating a prediction expression for resource usage rates on the basis of data of a certain threshold value or more in the third log data, and calculating predicted values of the resource usage rates, on the basis of the prediction expression and the load definition.

According to the aspects of the present invention, it is possible to predict the relationships between the loads and the resource usages with high accuracy.

### BRIEF DESCRIPTION OF THE DRAWINGS

The above-mentioned object, other objects, features, and advantages are further clarified by the preferred embodiments to be described later and the following accompanying drawings.

FIG. 1 is a block diagram illustrating a structure of a capacity management support apparatus according to a first embodiment of the present invention.

FIG. 2 is a diagram illustrating an example of a type definition.

FIG. 3 is a diagram illustrating an example of a load definition.

FIG. 4 is a flowchart illustrating a processing flow of the capacity management support apparatus according to the first embodiment of the present invention.

FIG. 5 is a diagram illustrating an example of logs which are held by the monitoring target system.

FIG. 6 is a diagram illustrating an example of first log data which is extracted by log acquisition unit.

FIG. 7 is a diagram illustrating an example of second log data which is extracted by log distribution estimation unit.

FIG. 8 is a diagram illustrating an example of a distribution density function which is estimated by the log distribution estimation unit.

FIG. 9 is a diagram illustrating an example of a prediction expression which is derived by resource usage rate prediction unit.

FIG. 10 is a diagram illustrating an example of predicted values which are derived by the resource usage rate prediction unit.

FIG. 11 is a block diagram illustrating a structure of a capacity management support apparatus according to a second embodiment of the present invention.

FIG. 12 is a diagram illustrating an example of a sorting definition.

FIG. 13 is a flowchart illustrating a processing flow of the capacity management support apparatus according to the second embodiment of the present invention.

FIG. 14 is a block diagram illustrating a structure of a capacity management support apparatus according to a third embodiment of the present invention.

FIG. 15 is a diagram illustrating an example of a correlation definition.

FIG. 16 is a flowchart illustrating a processing flow of the capacity management support apparatus according to the third embodiment of the present invention.

FIG. 17 is a diagram illustrating an example of the second log data, which is extracted by the log distribution estimation unit, in the third embodiment of the present invention.

FIG. 18 is a block diagram illustrating a structure of a capacity management support apparatus according to a fourth embodiment of the present invention.

FIG. 19 is a diagram illustrating an example of a safety factor definition.

FIG. 20 is a flowchart illustrating a processing flow of the capacity management support apparatus according to the fourth embodiment of the present invention.

FIG. 21 is a block diagram illustrating a structure of a capacity management support apparatus according to a fifth embodiment of the present invention.

FIG. 22 is a diagram illustrating an example of a service level definition.

FIG. 23 is a diagram illustrating a processing flow of the capacity management support apparatus according to the fifth embodiment of the present invention.

FIG. 24 is a block diagram illustrating a structure of a capacity management support apparatus according to a sixth embodiment of the present invention.

FIG. 25 is a diagram illustrating an example of a structure definition.

FIG. 26 is a flowchart illustrating a processing flow according to the sixth embodiment of the present invention.

### DESCRIPTION OF EMBODIMENTS

Hereinafter, the embodiments of the present invention will be described with reference to the drawings. In addition, in all drawings, the same components will be represented by the same reference numerals, and description will not be repeated.

### First Embodiment

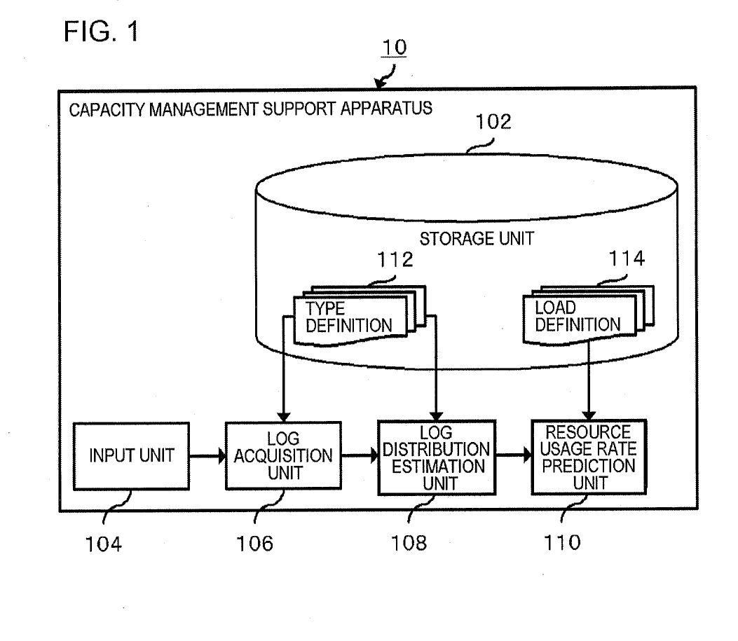

FIG. 1 is a block diagram illustrating a structure of a capacity management support apparatus 10 according to the first embodiment of the present invention. The capacity management support apparatus 10 includes a storage unit 102, an input unit 104, a log acquisition unit 106, a log distribution estimation unit 108, and a resource usage rate prediction unit 110.

The storage unit 102 stores a type definition 112 and a load definition 114.

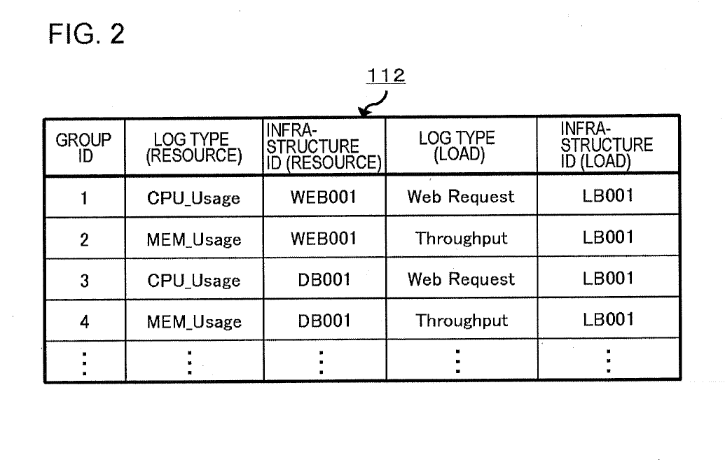

The type definition 112 defines correspondence between the logs for the loads and the logs for the resources acquired from the monitoring target system by the capacity management support apparatus 10. FIG. 2*is a diagram illustrating an example of the type definition 112. In FIG. 2, the row with the group ID of “1” indicates that, among the logs which are acquired from the monitoring target system, the log of the resource “CPU_Usage”, which is recorded by the infrastructure “WEB001”, corresponds to the log of the load “Web Request” which is recorded by the infrastructure “LB001”. It should be noted that the type definition 112 may define not only correspondence between the resources and the loads, but also correspondence between the resources. The type definition 112 is set in advance in, for example, the storage unit 102. Further, the capacity management support apparatus 10 monitors which log is recorded by which infrastructure in response to processing executed by the monitoring target system, and thus the type definition 112 may be dynamically set on the basis of the monitoring result.

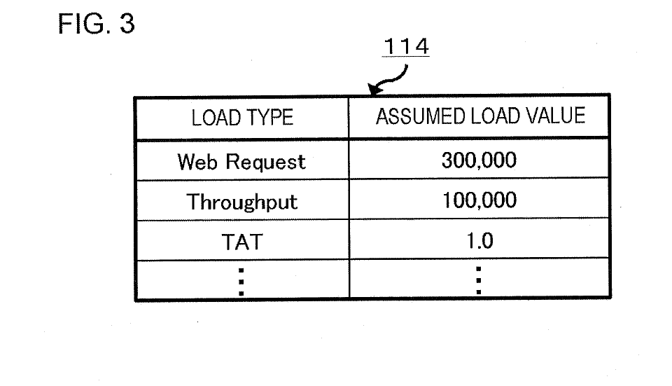

The load definition 114 defines the values of the loads (hereinafter referred to as assumed load values), which are assumed for the monitoring target system, in accordance with the types of the loads. FIG. 3 is a diagram illustrating an example of the load definition 114. The assumed load value may be, for example, a preset value, and may be an average value, a maximum value, or the like for each load type which is calculated on the basis of the statistics of the load values. The statistics of the load values, which are applied during a certain period of time, are obtained for each load type in the monitoring target system.

The input unit 104 acquires input information from a different apparatus which is positioned outside the capacity management support apparatus 10, a storage region of the capacity management support apparatus 10, or the like.

The log acquisition unit 106 determines the types of the logs to be extracted, on the basis of the input information and the type definition 112. In addition, the log acquisition unit 106 extracts information on the determined log types among the logs of the monitoring target system, thereby creating first log data.

The log distribution estimation unit 108 extracts information on the specific resources and loads from the first log data on the basis of the groups of the log types which are defined by the type definition 112, thereby creating second log data. Next, the log distribution estimation unit 108 estimates a distribution density function, which indicates actual distribution of the second log data, on the basis of the second log data. Then, the log distribution estimation unit 108 selects a range, which satisfies a specific condition, in the distribution density function, and extracts the second log data which is present in the range, thereby creating third log data.

The resource usage rate prediction unit 110 calculates a prediction expression, which indicates a relationship of groups defined by the type definition 112, on the basis of the third log data of a certain threshold value or more. Then, the resource usage rate prediction unit 110 substitutes the assumed load values, which are defined by the load definition 114, into the prediction expression, thereby calculating predicted values of the resource usage rates.

It should be noted that the components of the capacity management support apparatus 10 shown in the drawings do not indicate hardware unit structures, but indicate function unit blocks. The components of the capacity management support apparatus 10 are implemented by arbitrary combinations between hardware and software. The hardware and software mainly include a CPU of an arbitrary computer, a memory, programs that implement the components loaded in the memory in the drawing, a storage medium such as a hard disk storing the programs, and an interface for network connection. In addition, there are various modified examples of the implementation method and apparatus.

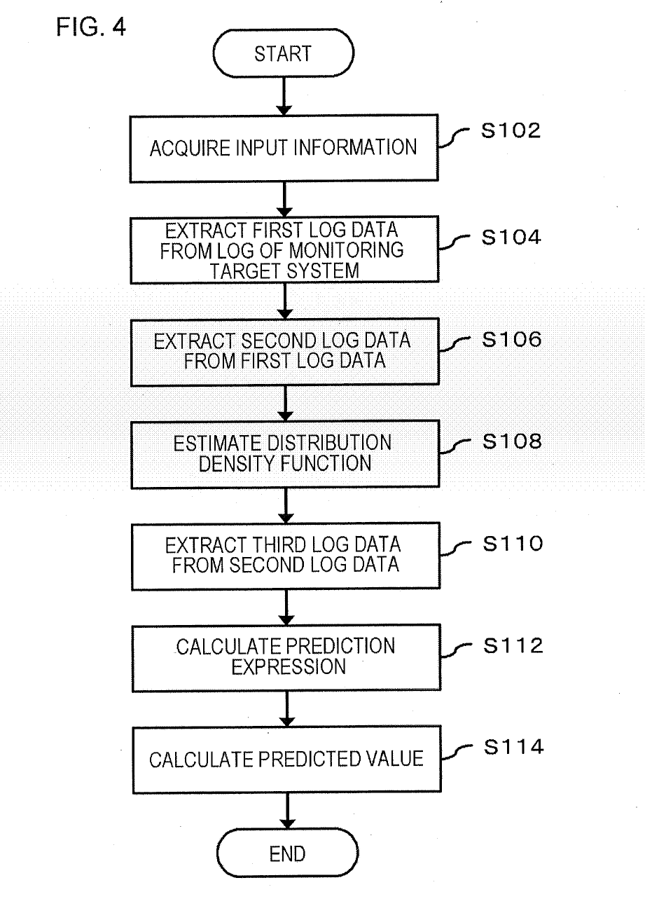

The processing flow in the present embodiment will be described with reference to FIGS. 4 to 10.

FIG. 4 is a flowchart illustrating the processing flow of the capacity management support apparatus 10 according to the first embodiment of the present invention. First, the input unit 104 acquires information on resources for predicting the usage rates (S102). The information on the resources is acquired, for example, in a way that a user performs an input by using the Graphical User Interface (GUI), the Character User Interface (CUI), or the like. Further, the information on the resources may be input from different software through the Application Programming Interface (API). Furthermore, the information on the resources may be acquired by reading files which contain necessary information recorded therein and which are not shown. The input unit 104 transmits the acquired information to the log acquisition unit 106.

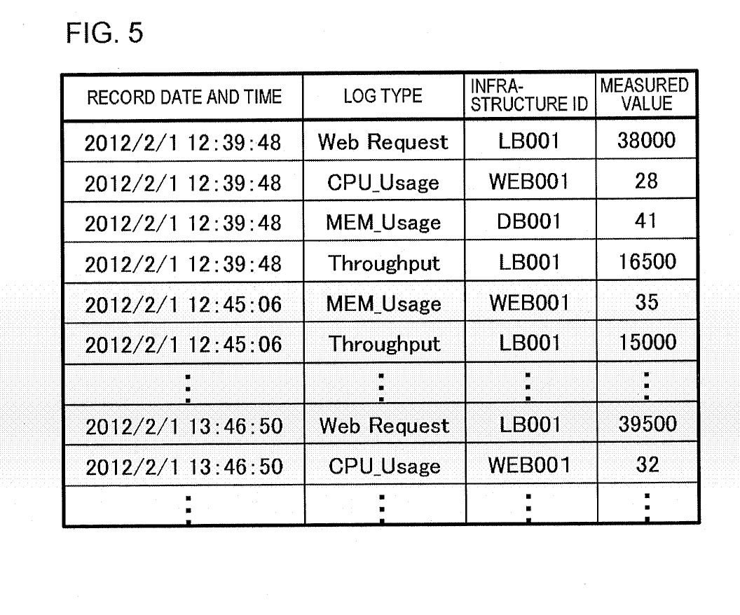

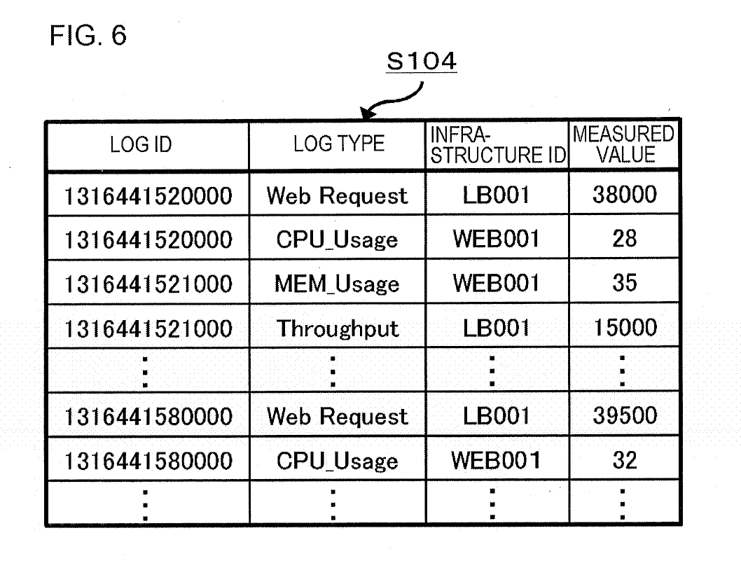

The log acquisition unit 106 extracts information, which is based on the information received from the input unit 104 and the type definition 112, among the logs in which the loads and the resource usages of the monitoring target system are recorded, as shown in FIG. 5, thereby creating the first log data (S104). For example, when receiving the resources “CPU_Usage” and “MEM_Usage” and the infrastructure ID “WEB001” as input information from the input unit 104, the log acquisition unit 106 creates the first log data shown in FIG. 6, on the basis of the input information and the type definition 112. Specifically, in the type definition shown in FIG. 2, the information, which corresponds to the “CPU_Usage” and the “WEB001”, is defined as “Web Request” and “LB001”. Further, in the type definition shown in FIG. 2, the information, which corresponds to the “MEM_Usage” and the “WEB001”, is defined as “Throughput” and “LB001”. Accordingly, the log acquisition unit 106 extracts the logs of the “Web Request” and “LB001” through the “CPU_Usage” and the “WEB001”, and extracts the logs of the “Throughput” and the “LB001” through the “MEM_Usage” and the “WEB001”. Further, at this time, the log acquisition unit 106 also additionally extracts the logs of the “CPU_Usage” and the “WEB001” and the logs of the “MEM_Usage” and the “WEB001” as the input information. When creating the first log data, the log acquisition unit 106 checks the time, at which the extracting target logs are recorded, and assigns the same log ID to the logs which are recorded at the same time. The log acquisition unit 106 transmits the created first log data to the log distribution estimation unit 108.

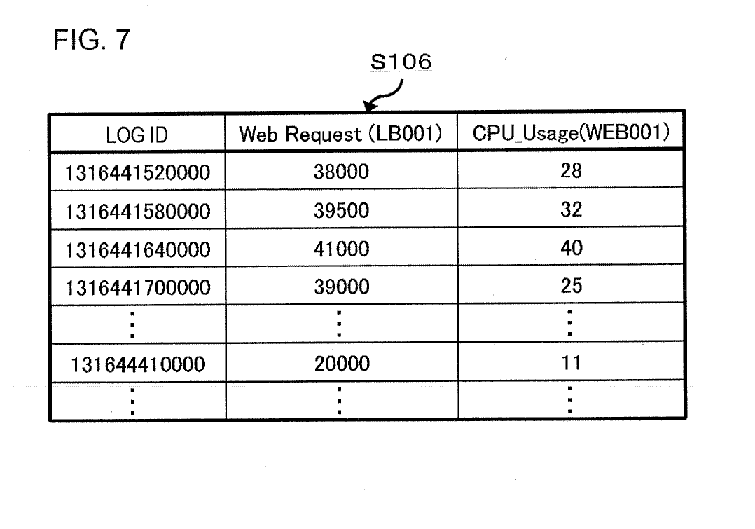

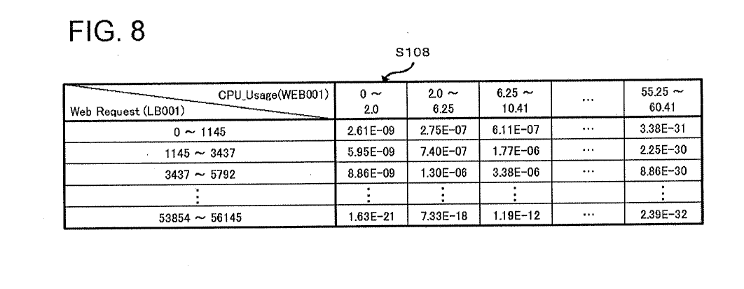

The log distribution estimation unit 108 extracts information, which is specified by the groups defined by the type definition 112, from the first log data which is received from the log acquisition unit 106. The log distribution estimation unit 108 is able to determine that, for example, the logs of the “CPU_Usage” recorded as “WEB001” correspond to the logs of the “Web Request” recorded as “LB001”, from the type definition shown in FIG. 2. Then, the log distribution estimation unit 108 extracts information from the first log data by using the correspondence relationship of the log type, thereby creating the second log data, for example, as shown in FIG. 7 (S106). Then, the log distribution estimation unit 108 estimates the distribution density function on the basis of the second log data (S108). FIG. 8 is a diagram illustrating an example of the distribution density function which is estimated by the log distribution estimation unit 108. In FIG. 8, the horizontal axis indicates the usage of the resource “CPU_Usage”, and the vertical axis indicates the value of the load “Web Request”. Further, in FIG. 8, for example, when the usage of the resource “CPU_Usage” is in the range of “0 to 2.0”, at the first upper left cell, the probability that the value of the load “Web Request” is in the range of “0 to 1145” is “2.61E-09”. Furthermore, in contrast, when the value of the load “Web Request” is in the range of “0 to 1145”, the probability that the usage of the “CPU_Usage” is in the range of “0 to 2.0” is “2.61E-09”. Moreover, the log distribution estimation unit 108 is able to estimate the distribution density function by using the nonparametric method typified by for example a kernel density estimation method or the like. Then, the log distribution estimation unit 108 selects the range in which the reliability is supposed to be high, in the distribution density function which is estimated in S108. For example, the log distribution estimation unit 108 selects a 99% confidence interval, a 95% confidence interval, the top XX %, or the like as the range in which the reliability is high, in the distribution density function which is estimated in S108. The log distribution estimation unit 108 extracts the second log data which is present in the estimated range, thereby creating the third log data (S110). The log distribution estimation unit 108 transmits the created third log data to the resource usage rate prediction unit 110.

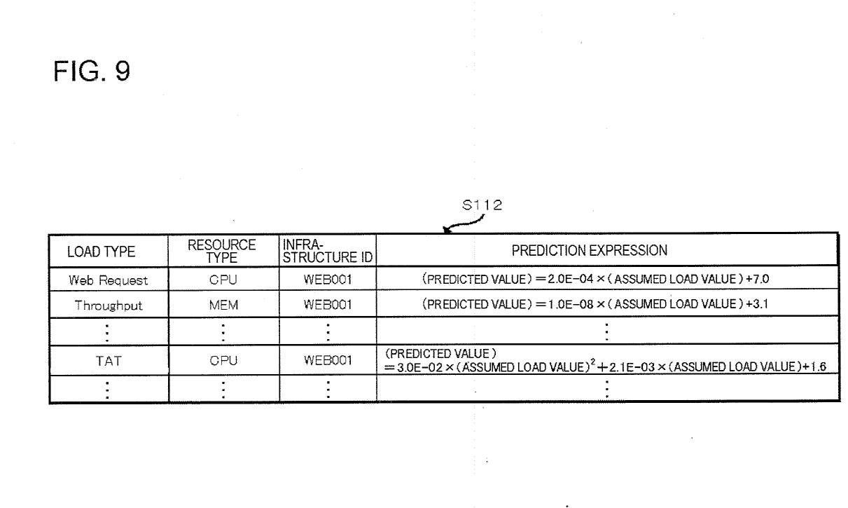

The resource usage rate prediction unit 110 calculates the prediction expression for the resource usage rates from the third log data which is received from the log distribution estimation unit 108 (S112). First, the resource usage rate prediction unit 110 selects the data of a certain threshold value or more among the third log data as data used in deriving the prediction expression. For example, the resource usage rate prediction unit 110 selects data, which has values equal to or greater than the certain value, on the basis of not only the values of the third log data but also the average value or the median value of the third log data and the distribution of and distance between the data pieces included in the third log data. Further, the resource usage rate prediction unit 110 may select data, which has values equal to or greater than the certain value, on the basis of the distance or the inclination of the lines connecting the data pieces and the origin point when the resource usage and the load value are represented as 2-dimensional coordinate axes. For example, the resource usage rate prediction unit 110 selects data, which corresponds to the top 50% of the “CPU_Usage”, in the third log data. Next, the resource usage rate prediction unit 110 derives equations, which represent relationships between the resource usages and the loads as shown in FIG. 9, by using the data of the range which is selected on the basis of the threshold value. The resource usage rate prediction unit 110 derives an approximate function from the selected data by using, for example, a method such as the least-squares method, polynomial approximation, or the fitting for multiple equations separately defined, and sets the approximate function as the prediction expression. When calculating the prediction expression, the resource usage rate prediction unit 110 converts the log types into the corresponding resource types. For example, when the log type is the “CPU_Usage”, the resource usage rate prediction unit 110 converts the log type into the “CPU” which is the corresponding resource type. Here, for example, the resource usage rate prediction unit 110 stores information, which defines correspondence of the log types and the resource types, in the storage unit 102, and is able to convert the log types and the resource types on the basis of the definition. In addition, the resource usage rate prediction unit 110 may use the following functions as the approximate function: a linear function such as a direct function, a quadratic or higher-degree polynomial, a logarithm function, a power function, an exponential function, or the like. The approximate function used as the prediction expression may be determined on the basis of the definition of the approximate function used for each log type, where the definition is stored in the storage unit 102. In addition, the resource usage rate prediction unit 110 may calculate the determination factor shown in the following Expression 1 for each approximate function, and may select the function on the basis of the threshold value.

$$\begin{matrix}[ Numerical Expression 1 ] & \\ R = 1 - \frac{{{Σ}_{i} ( yi - fi )}^{2}}{{{Σ}_{i} ( yi - ya )}^{2}} & ( 1 )\end{matrix}$$

Expression 1 is an expression for calculating the determination factor that indicates how appropriate the approximate function is for the selected data. Further, in Expression 1, R is the determination factor, yi is a value of the data, fi is a solution of the approximate function, and ya is an average value of the data. In addition, the data, which corresponds to yi, in the data, which is input to the resource usage rate prediction unit 110, indicates the resource usages such as “CPU_Usage (WEB001)”. Furthermore, the solution fi of the approximate function is calculated by substituting the data, indicating the loads such as “Web Request (LB001)” in the data which is input to the resource usage rate prediction unit 110, into the approximate function. The resource usage rate prediction unit 110 selects the approximate function, in which the largest determination factor is set, as the prediction expression.

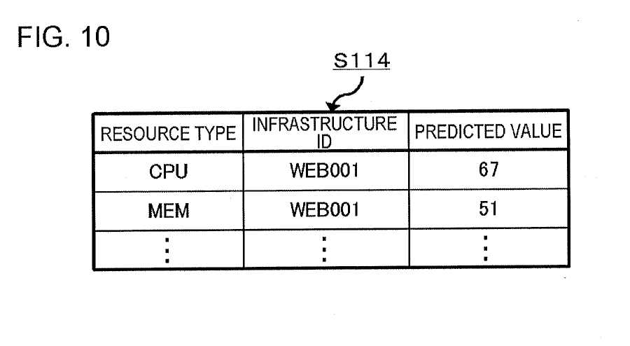

Next, the resource usage rate prediction unit 110 calculates the predicted values of the resource usage rates, as shown in FIG. 10, on the basis of the assumed load values of the load definition 114 and the prediction expression calculated in S112 (S114). For example, in FIG. 9, attention is focused on the relational expression in which the load type is the “Web Request” and the resource type is the “CPU” at the infrastructure ID “WEB001”. When the load definition 114 is set as shown in FIG. 3, the resource usage rate prediction unit 110 substitutes the assumed load value “300,000” of the “Web Request” into the prediction expression shown in FIG. 9, thereby calculating the predicted value of the “CPU” as “67”. This means that, in the monitoring target system, when there is the “Web Request” of the assumed load value, the usage rate of the resource “CPU” of the infrastructure “WEB001” is 67%.

In addition, the capacity management support apparatus 10 may provide a user with the prediction expression and the predicted values calculated by the resource usage rate prediction unit 110 by using a display unit which is not shown. For example, the capacity management support apparatus 10 may display the prediction expression and the predicted values on a display device. Further, the capacity management support apparatus 10 may print a ledger sheet on which the prediction expression and the predicted values are printed by using a printer or the like.

As described above, in the present embodiment, the actual distribution of the logs of the monitoring target system is calculated. Then, the resource usages are predicted on the basis of the actual distribution. Thereby, it is possible to correct errors and loss in the actual measured values of the logs in the monitoring target system. Consequently, according to the configuration, the accuracy in prediction of the resource usages are more improved than that in the method of directly using the actual measured logs.

### Second Embodiment

The present embodiment is the same as the first embodiment except for the following points.

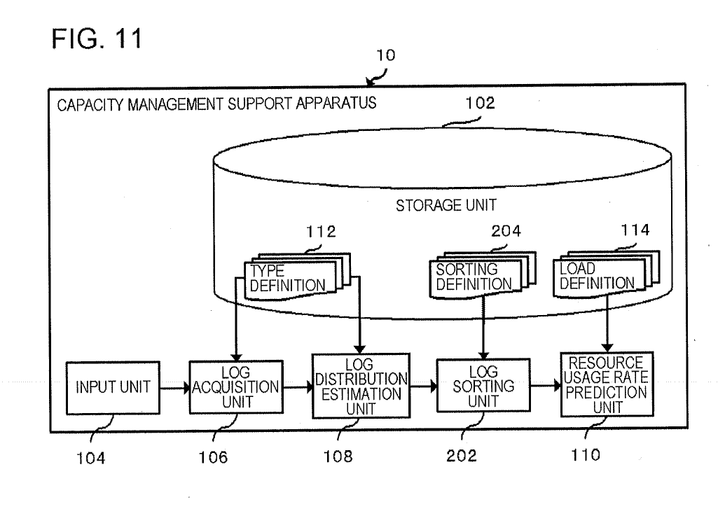

FIG. 11 is a block diagram illustrating a structure of a capacity management support apparatus 10 according to the second embodiment of the present invention. In the present embodiment, the capacity management support apparatus 10 further includes a log sorting unit 202. Further, the storage unit 102 further stores a sorting definition 204.

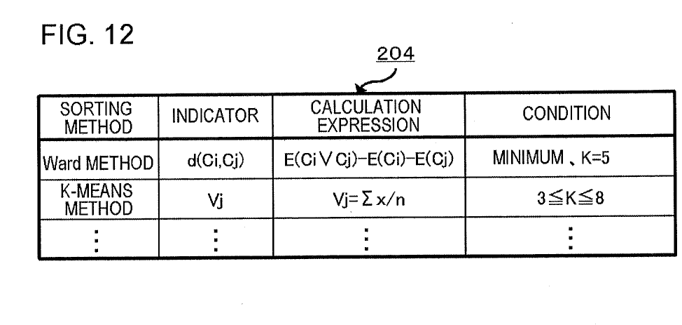

The sorting definition 204 defines a method of sorting data pieces included in the third log data. FIG. 12 is a diagram illustrating an example of the sorting definition 204. Available sorting methods using the sorting definition 204 may include, for example, a Ward method, a K-means method, a shortest distance method, a longest distance method, a group average method, and the like. Indicators are threshold values which are used when the data pieces included in the third log data are sorted. The calculation expressions are expressions for calculating the indicators. The conditions indicate the threshold values relating to the indicators, the number of the sorted data pieces, and the like.

By using the third log data which is output by the log distribution estimation unit 108 as an input, the log sorting unit 202 sorts the data pieces included in the third log data into a plurality of sets on the basis of the sorting definition 204.

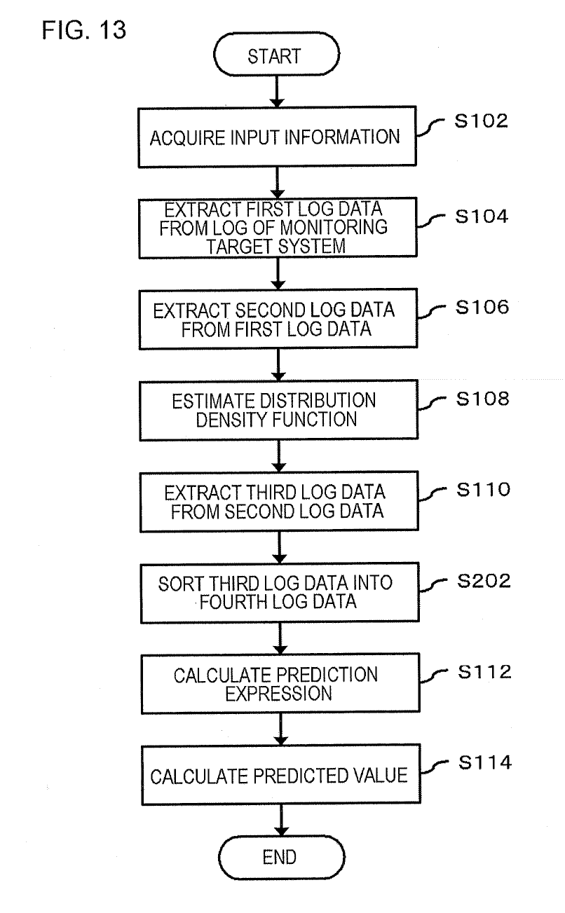

The processing flow in the present embodiment will be described with reference to FIG. 13.

The log sorting unit 202 receives the third log data from the log distribution estimation unit 108. Then, on the basis of the sorting method which is defined by the sorting definition 204, the data pieces, which are included in the third log data, are sorted into a plurality of fourth log data pieces (S202). In the present embodiment, each fourth log data piece is formed by clustering the data pieces, which are similar in the relationship between the resource usage and the load, among the data pieces which are included in the third log data. For example, when the resource usages and the loads are represented as the 2-dimensional coordinate axes, the indicator for sorting the logs may be set as a distance between the origin point and each of the data pieces included in the third log data, an inclination of the line connecting the origin point and each of the data pieces of the third log data, or the like. It should be noted that, when the distance is set as the indicator, the Euclid square distance, the Minkowski distance, the Mahalanobis' generalized distance, or the like may be used. Here, the log sorting unit 202 may set, for example, a method for sorting the third log data, in advance, for each log type. The log sorting unit 202 transmits all the sorted fourth log data pieces to the resource usage rate prediction unit 110.

The resource usage rate prediction unit 110 uses, for example, the fourth log data, of which the median value is at the maximum, among the plurality of fourth log data pieces, which are sorted by the log sorting unit 202, in order to derive the prediction expression. The subsequent processing is the same as that of the first embodiment except that the fourth log data is used in place of the third log data, and thus the description thereof is not repeated.

As described above, in the present embodiment, it is also possible to obtain the same effect as the first embodiment. In the present embodiment, the log sorting unit 202 sorts the data pieces, which are included in the third log data, into the respective plurality of fourth log data pieces, on the basis of the sorting definition 204. Thereby, when the third log data is created, although the logs for various processes with different tendencies are mixed, the logs for processes having the same tendency are sorted as the fourth log data. Hence, by reducing the variation in data pieces which are used to calculate the prediction expression, the accuracy in prediction of the resource usages is further improved.

### Third Embodiment

The present embodiment is the same as the second embodiment except for the following points.

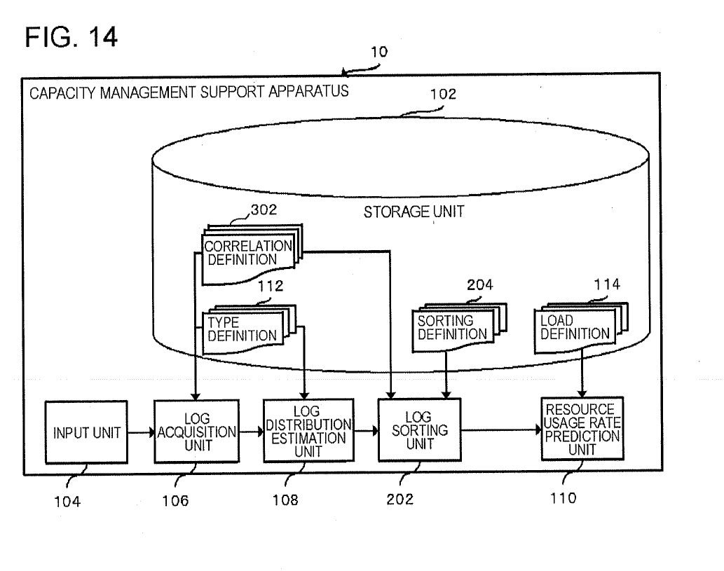

FIG. 14 is a block diagram illustrating a structure of a capacity management support apparatus 10 according to the third embodiment of the present invention. In the present embodiment, the storage unit 102 further stores a correlation definition 302.

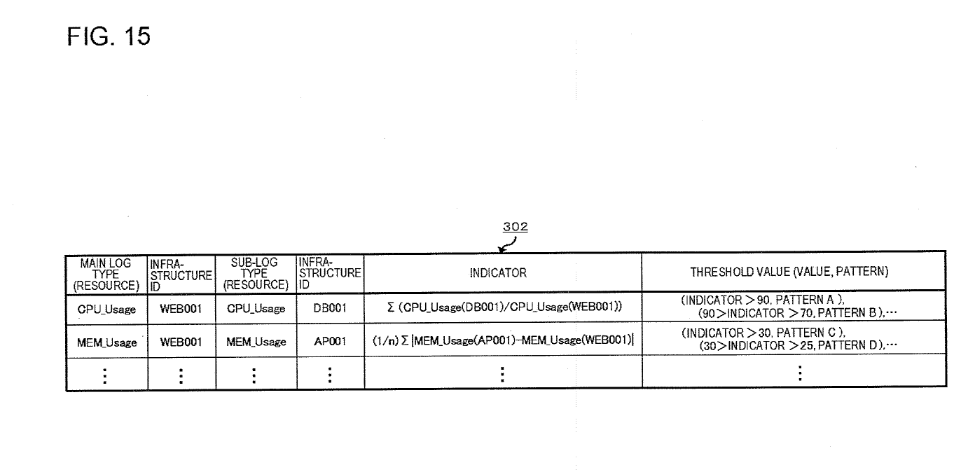

The correlation definition 302 defines the log types (hereinafter referred to as main log types), which are acquired by the input unit 104, and the log types (hereinafter referred to as sub-log types) which have correlations. Further, the correlation definition 302 defines patterns to which the fourth log data pieces belong, on the basis of the resource usages of the main log types and the resource usages of the sub-log types. FIG. 15 is a diagram illustrating an example of the correlation definition 302. For example, in FIG. 15, when the “CPU_Usage” of the infrastructure “WEB001” is set as the main log type, this indicates that the “CPU_Usage” of the infrastructure “DB001” is the sub-log type indicating the correlation. The indicators are used in order to classify the fourth log data pieces, which are sorted by the log sorting unit 202, into the patterns in accordance with the tendencies of the processes. The indicator is calculated by the numerical expression which is set for each correspondence between the main log type and the sub-log type. By comparing the calculated indicators with the conditions which are set by the threshold values, it is possible to determine what tendency each fourth log data piece sorted by the log sorting unit 202 indicates.

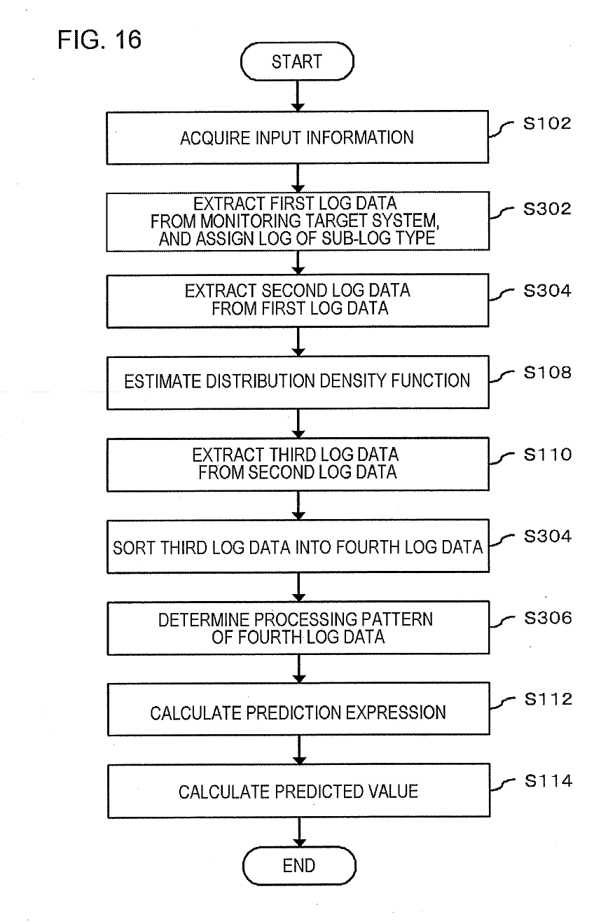

The processing flow in the present embodiment will be described with reference to FIG. 16.

The log acquisition unit 106 acquires the logs of the sub-log types corresponding to the main log types, which are acquired by the input unit 104, on the basis of the correlation definition 302, and assigns the logs to the first log data which is acquired in the first embodiment (S302). In the first embodiment, the logs of the “Web Request” and “LB001” are extracted from the “CPU_Usage” and the “WEB001”, and the logs of the “Throughput” and the “LB001” are extracted from the “MEM_Usage” and the “WEB001”. Further, at this time, the logs of the “CPU_Usage” and the “WEB001” and the logs of the “MEM_Usage” and the “WEB001” as the input information are additionally extracted. In the present embodiment, the log acquisition unit 106 further extracts the logs of the “CPU_Usage” and the “DB001” as the logs of the sub-log types corresponding to the “CPU_Usage” and the “WEB001” which are the main log types, on the basis of the correlation definition 302. Furthermore, the log acquisition unit 106 further extracts the logs of the “MEM_Usage” and the “AP001” as the logs of the sub-log types corresponding to the “MEM_Usage” and the “WEB001” which are the main log types, on the basis of the correlation definition 302.

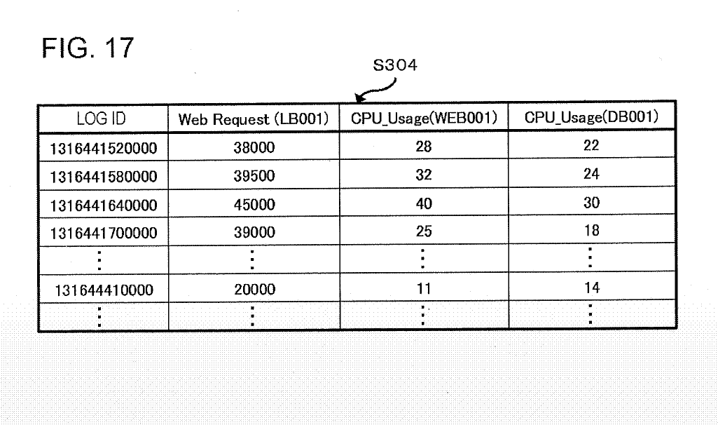

Next, the log distribution estimation unit 108 extracts the sub-log type data from the first log data in addition to the data of the loads and the main log types, thereby creating the second log data (S304). Focusing on the “CPU_Usage” and the “WEB001”, for example as shown in FIG. 17, the column of the “CPU_Usage (DB001)” is further extracted in addition to the information of FIG. 7. In addition, in processes from an estimating process of the distribution density function to an extracting process of the third log data, the log distribution estimation unit 108 performs the processes on the basis of the information of the loads and the main log types, in a similar manner to the first and second embodiments, without using the information of the sub-log types. That is, here, the third log data, which is transmitted to the log sorting unit 202, is data in which the column of the sub-log types is added to the third log data which is transmitted in the first and second embodiments.

Next, the log sorting unit 202 applies the sorting method of the sorting definition 204 to the data for the sub-log types and the data for the main log types included in the third log data. Then, by performing clustering on the basis of the result, the third log data is sorted into the fourth log data pieces (S304).

Further, the log sorting unit 202 determines the tendencies of the processes, which are indicated by the fourth log data sorted in S304, on the basis of the threshold values and the indicators which are defined in the correlation definition 302, and assigns the pattern information, which indicates the tendencies, to the fourth log data (S306). Here, it is assumed that the log sorting unit 202 uses the correlation definition shown in FIG. 15. In this case, the log sorting unit 202 determines the pattern A if the sum of the values obtained by subtracting the “CPU_Usage” of the “WEB001” from the “CPU_Usage” of the “DB001” is greater than 90. Furthermore, the log sorting unit 202 determines the pattern B if the sum of the values obtained by subtracting the “CPU_Usage” of the “WEB001” from the “CPU_Usage” of the “DB001” is greater than 70 and is equal to or less than 90. Moreover, the log sorting unit 202 determines the pattern C if the sum of the values obtained by subtracting the “CPU_Usage” of the “WEB001” from the “CPU_Usage” of the “DB001” is equal to or less than 70. In addition, the log sorting unit 202 assigns the determined pattern information to each sorted fourth log data piece, and transmits the information to the resource usage rate prediction unit 110.

The resource usage rate prediction unit 110 targets the fourth log data, which has the largest number of patterns, among the sorted fourth log data pieces, and calculates the predicted values and the prediction expression of the resource usage rates, in a similar manner to the second embodiment. For example, when the sorting is performed using the Ward method shown in the sorting definition 204, the sorting may be performed such that the number of the pattern A is 3, the number of the pattern B is 1, and the number of the pattern C is 1. In this case, the resource usage rate prediction unit 110 applies the processes, which are the same as those of the second embodiment, to the three sets of the pattern A. In addition, the resource usage rate prediction unit 110 may calculate the predicted values and the prediction expression of the resource usage rates, for each pattern information, with reference to the pattern information. For example, the resource usage rate prediction unit 110 may calculate the prediction expression and the predicted values, relative to the assumed load values defined in the load definition 114, in each case of the pattern A, the pattern B, and the pattern C.

As described above, in the present embodiment, it is also possible to obtain the same effect as the first and second embodiments. Further, in the present embodiment, by using the correlation definition 302, the pattern information, which indicates the tendencies of the processes performed by the monitoring target system, is provided. Then, the predicted values and the prediction expression of the resource usage rates are calculated from the logs which are sorted for each pattern information. Thereby, in accordance with the patterns of the processes performed by the monitoring target system, that is, in accordance with the characteristics of the processes performed by the monitoring target system, it is possible to predict the resource usages.

### Fourth Embodiment

The present embodiment is the same as the first embodiment except for the following points.

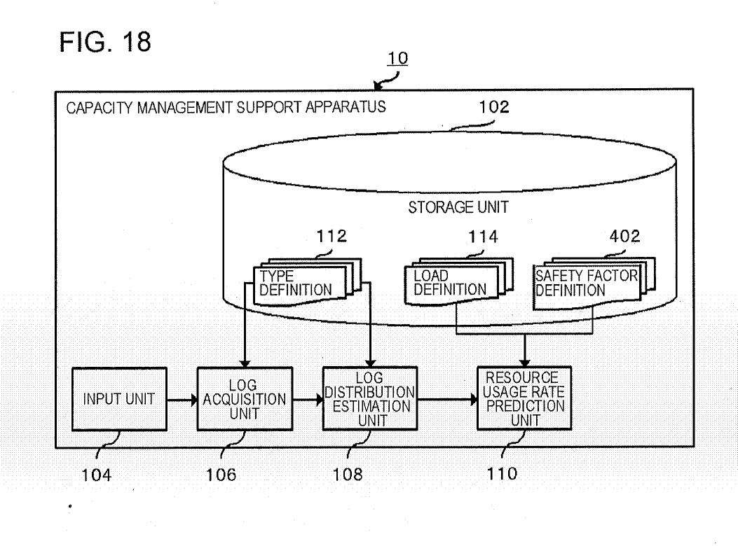

FIG. 18 is a block diagram illustrating a structure of a capacity management support apparatus 10 according to the fourth embodiment of the present invention. In the present embodiment, the storage unit 102 further stores a safety factor definition 402. The safety factor definition 402 defines a safety factor for each resource type or for all the resource types. It should be noted that the safety factor is a factor for correcting the predicted value having influence on errors and the like.

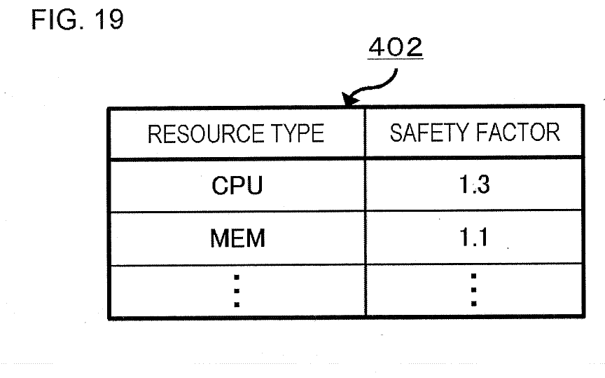

FIG. 19 is a diagram illustrating an example of the data of the safety factor definition 402. The safety factor definition 402 includes at least the resource types and the safety factors. The resource type indicates the type of the resource to which the safety factor is applied. The safety factor indicates a value used in correcting the predicted value.

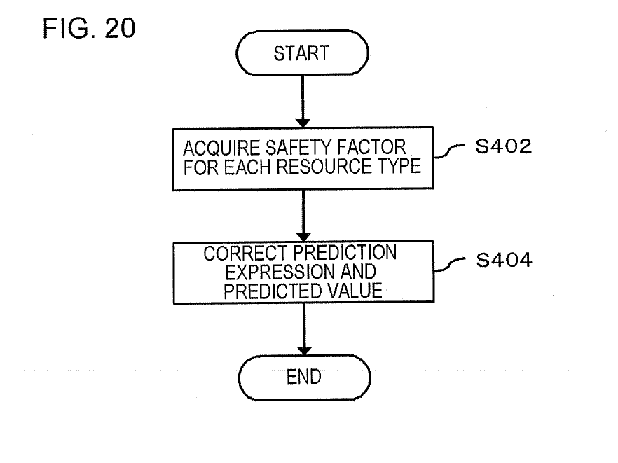

The processing flow in the present embodiment will be described with reference to FIG. 20.

First, after calculating the predicted values in a similar manner as the first to third embodiments, the resource usage rate prediction unit 110 reads the safety factor definition 402, and acquires the safety factors corresponding to the calculated resource types (S402).

Next, the resource usage rate prediction unit 110 corrects the predicted values on the basis of the calculated resource type and the safety factors which are acquired in S402 (S404). For example, it is assumed that the storage unit 102 stores the safety factor definition 402 shown in FIG. 19. Further, it is assumed that the target resource type is “CPU”, the prediction expression acquired by the resource usage rate prediction unit 110 is “(predicted value)=2.0E−04×(assumed load value)+7.0”, and the calculated predicted value is “67”. The safety factor of the “CPU”, which is read from the safety factor definition 402 shown in FIG. 19, is “1.3”. Hence, the prediction expression of the “CPU” is corrected to “(predicted value)=2.6E−04×(assumed load value)+9.1”, and the predicted value is calculated as “87.1”.

As described above, in the present embodiment, it is also possible to obtain the same effect as the first embodiment. In the present embodiment, by using the safety factor definition 402, the predicted value, which is calculated by the resource usage rate prediction unit 110, is corrected. Thereby, the resource usage rate prediction unit 110 is able to predict the resource usage for the assumed load value with a sufficient capacity. Hence, compared with the case where the safety factor definition 402 is not used, it is possible to detect early that the capacity of the monitoring target system is insufficient. Accordingly, it is possible to more stably activate the monitoring target system. In addition, the present embodiment may be applied to the second and third embodiments.

### Fifth Embodiment

The present embodiment is the same as the first embodiment except for the following points.

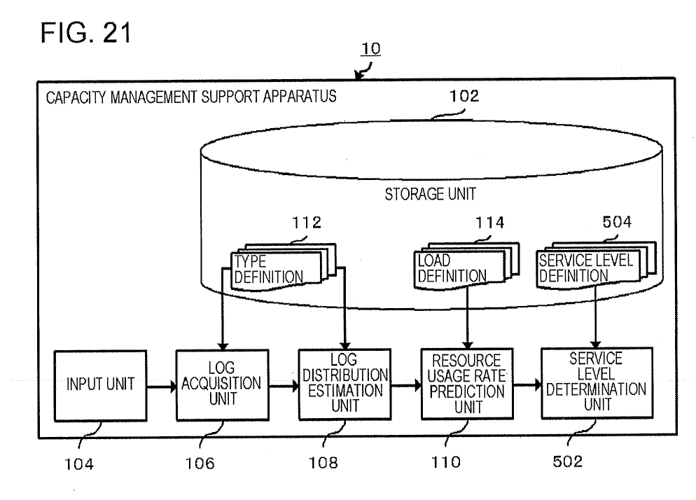

FIG. 21 is a block diagram illustrating a structure of a capacity management support apparatus 10 according to the fifth embodiment of the present invention. The capacity management support apparatus 10 further has a service level determination unit 502, and the storage unit 102 further stores a service level definition 504.

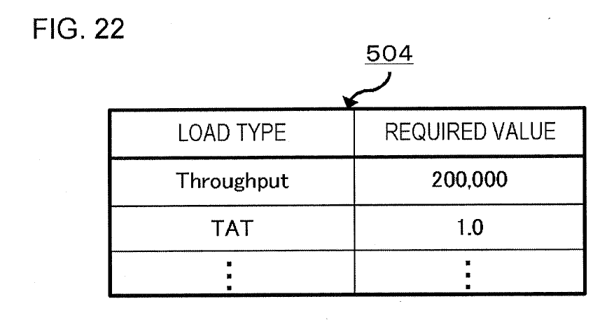

The storage unit 102 stores the service level definition 504 that indicates a performance value which is required for each load type. FIG. 22 is a diagram illustrating an example of the service level definition 504. The service level definition 504 includes, for example, load types, and the required values each of which is defined for each load type. The required value is defined on the basis of the target value or the like of the performance required for a built system.

The service level determination unit 502 determines whether or not the current structure of the monitoring target system satisfies the required service level, on the basis of the required value of the service level definition 504 and the prediction expression of the resource usage rate predicted by the resource usage rate prediction unit 110.

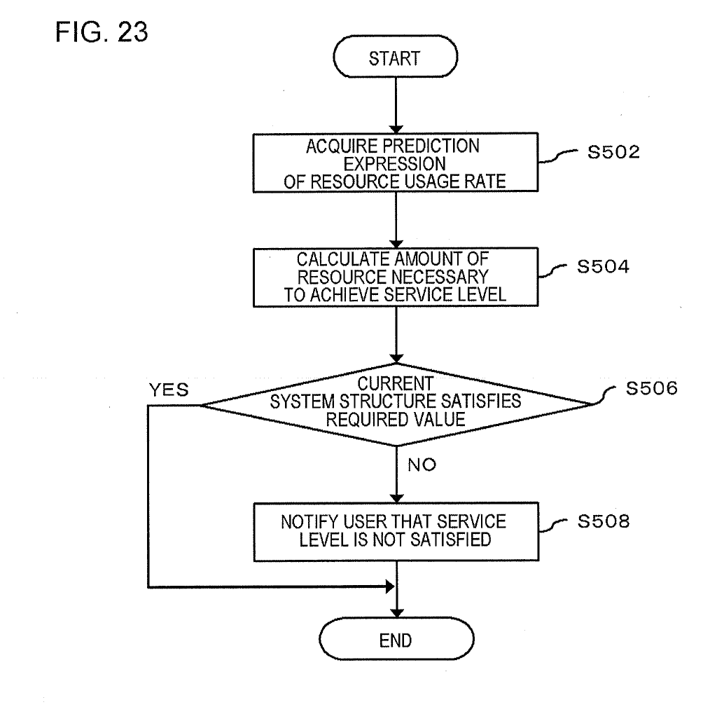

The processing flow in the present embodiment will be described with reference to FIG. 23.

First, the service level determination unit 502 acquires the prediction expression of the resource usage rates from the resource usage rate prediction unit 110 (S502).

Next, the service level determination unit 502 calculates the amount of resource, which is necessary to achieve the service level, on the basis of the required value of the service level definition 504 and the prediction expression of the resource usage rate acquired in S502 (S504). Then, the service level determination unit 502 determines whether or not the current structure of the monitoring target system satisfies the service level, on the basis of the amount of resource calculated in S504. As a result of the determination, if the current structure of the system satisfies the required value (YES in S506), the service level determination unit 502 determines that the current system structure has no problem, and terminates the process. For example, it is assumed that the prediction expression, which is acquired in S502, relates to the load “Throughput” and the resource “CPU_Usage”, and is “(predicted value)=3.0E−04×(assumed load value)+7.0”. The service level determination unit 502 reads the required value “200,000” of the “Throughput” from the service level definition 504. Then, the service level determination unit 502 substitutes the read required value for the assumed load value of the prediction expression. In the present example, the result of the substitution is “67”, and is thus not greater than “100”. In this case, the service level determination unit 502 is able to determine that the monitoring target system satisfies the service level.

In contrast, as a result of the determination, if the current system structure does not satisfy the required value (NO in S506), the service level determination unit 502 notifies a user that the current system structure does not satisfy the requirement, by using a display unit which is not shown (S508). For example, as a result of the substitution of the required value into the prediction expression which is acquired in S502, if the value is greater than “100”, the service level determination unit 502 is able to determine that the current system structure does not satisfy the service level.

It should be noted that, in the service level definition 504, the required values of the resource usages may be defined. By substituting the required value of the resource usage into the prediction expression, the service level determination unit 502 is able to calculate the maximum value of the load capable of maintaining the service level in the current system structure. Further, in S502, the service level determination unit 502 additionally acquires the predicted value which is calculated by the resource usage rate prediction unit 110, and is also able to determine a mismatch in the service level. For example, the service level determination unit 502 determines that the service level is not satisfied if the predicted value acquired in S502 is greater than the required value of the resource usage of the service level definition 504. In contrast, the service level determination unit 502 is able to determine that the service level is satisfied if the predicted value acquired in S502 is equal to or less than the required value of the resource usage of the service level definition 504.

As described above, in the present embodiment, it is also possible to obtain the same effect as the first embodiment. In the present embodiment, the amount of resource, which is necessary for the monitoring target system to maintain the set service level, is calculated from the predicted value which is predicted by the resource usage rate prediction unit 110. Further, it is determined whether or not the resource usage predicted for the assumed load value satisfies the set service level. Consequently, with such a configuration, a user is able to easily determine the timing for enhancing the structure of the monitoring target system.

It should be noted that the present embodiment may be applied to the second to fourth embodiments.

### Sixth Embodiment

The present embodiment is the same as the first embodiment except for the following points.

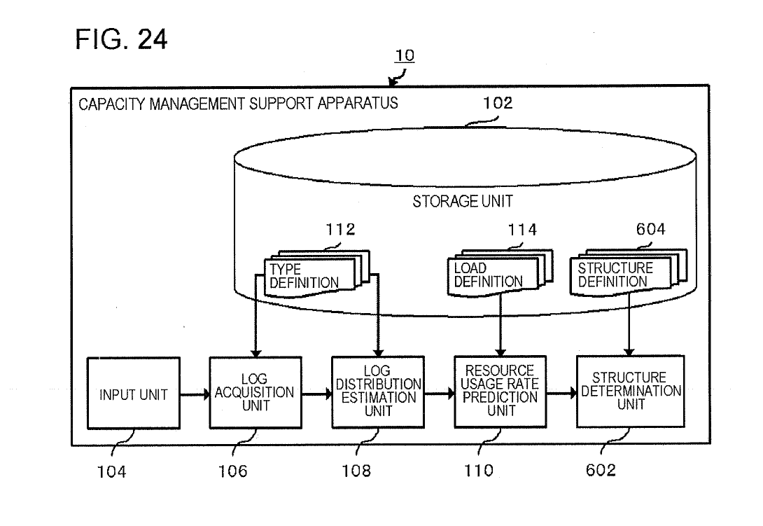

FIG. 24 is a block diagram illustrating a structure of a capacity management support apparatus 10 according to the sixth embodiment of the present invention. The capacity management support apparatus 10 further has a structure determination unit 602. Further, the storage unit 102 further stores a structure definition 604.

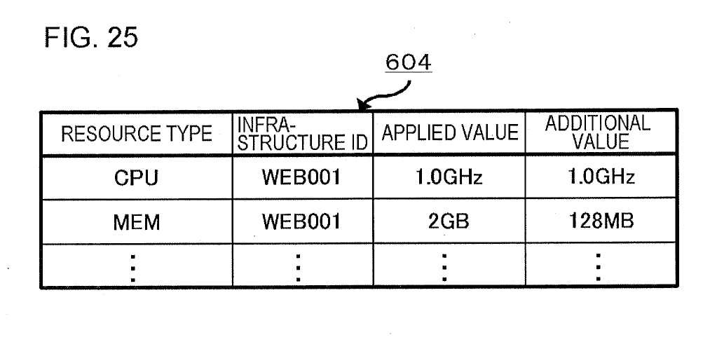

The storage unit 102 stores the structure definition 604 which is information on the structure. FIG. 25 is a diagram illustrating an example of the structure definition 604. In FIG. 25, the structure definition 604 includes, for example, resource types, infrastructure IDs, applied values, additional values, and the like. The data of the structure definition 604 may include the maximum values or the minimum values of the respective resource types. The resource type indicates a type of the resource constituting the system such as the CPU or the memory. The infrastructure ID indicates a name of the node including each resource. The applied value indicates a performance value of each resource which is currently mounted on the monitoring target system. The additional value indicates a unit of the resource which is added when each resource is enhanced.

The structure determination unit 602 determines whether or not to change the system structure, on the basis of the applied values of the structure definition 604 and the predicted values and the prediction expression of the resource usage rates predicted by the resource usage rate prediction unit 110.

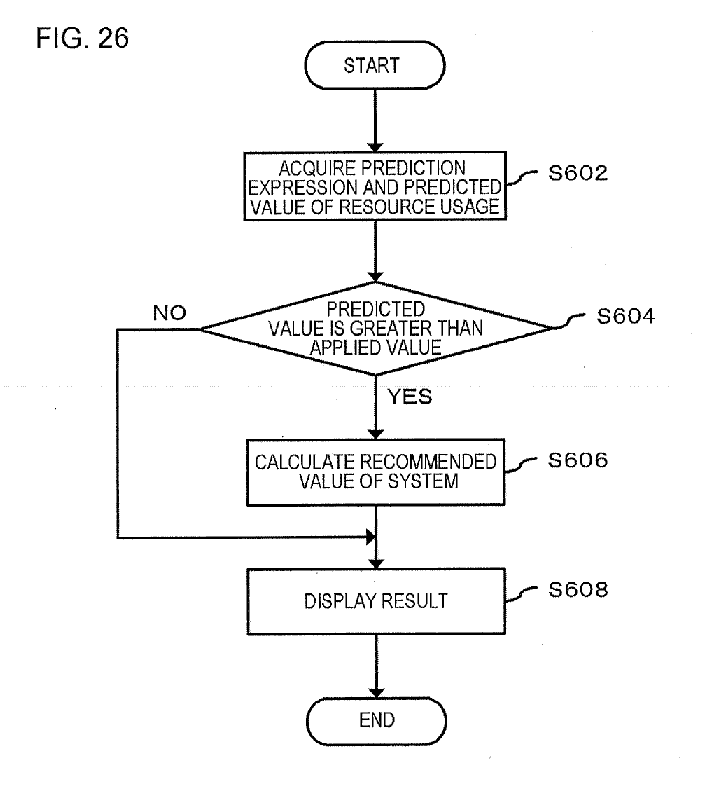

The processing flow in the present embodiment will be described with reference to FIG. 26.

First, the structure determination unit 602 acquires the predicted values and the prediction expression of the resource usage rates from the resource usage rate prediction unit 110 (S602).

Next, the structure determination unit 602 compares the predicted value of the resource usage rate, which is acquired in S602, with the applied value of the structure definition 604. As a result of the comparison, if the predicted value of the resource usage rate is greater than the applied value (YES in S604), the structure determination unit 602 determines that the performance of the resource currently mounted on the system is insufficient. For example, when the predicted value of the usage rate of the resource “CPU” of the node “WEB001” is greater than “100”, the structure determination unit 602 is able to determine that the performance of the resource “CPU” of the node “WEB001” currently mounted on the system is insufficient.

Next, the structure determination unit 602 determines by how much the amount of the resource is insufficient, thereby calculating the performance value of the system recommended on the basis of the additional value of the structure definition 604 (S606). For example, it is assumed that the predicted value of the “CPU” of the “WEB001” acquired in S602 is “106”. This means that, at the assumed load value, it is predicted that the resource usage rate of the “CPU” of the “WEB001” becomes 106%. Here, when the applied value and the additional value are as shown in FIG. 25, the predicted resource usage of the “CPU” of the “WEB001” is calculated as “1.0 (GHz)×1.06=1.06 (GHz)”. Accordingly, the structure determination unit 602 is able to determine that, as a recommended performance value of the system, it is preferable to add the additional value of one unit (1.0 GHz). Here, for example, likewise if the predicted value of the “CPU” of the “WEB001” acquired in S602 is greater than “200”, the structure determination unit 602 is able to determine that it is preferable to add the additional value of two units (2.0 GHz). Then, the structure determination unit 602 outputs the calculated result to the display unit (not shown in the drawing). In contrast, as a result of the comparison, if the predicted value of the resource usage is equal to or less than the applied value (NO in S604), the information to the effect that the current system structure has no problem is generated, and is output to the display unit. For example, if there is no problem in the current system structure, the display unit outputs a message such as “processing is possible” or “◯”. In contrast, if there is a problem in the current system structure, the display unit outputs information, which indicates the amount of resource to be added, in addition to a message such as “processing is impossible” or “x”.

The display unit provides the received information to a user (S608). The display unit displays the received information on, for example, a display device. Further, the display unit may provide the received information to a user in a way such as outputting the information to a ledger sheet by using a printer or the like.

As described above, in the present embodiment, it is also possible to obtain the same effect as the first to fifth embodiments. Further, in the present embodiment, it is possible to determine whether or not the current system structure is capable of dealing with the predicted load, on the basis of the performance value of the current system, the prediction expression, and the predicted value. Here, the performance value is determined by the structure definition 604, and the prediction expression and the predicted value are calculated by the resource usage rate prediction unit 110. Thereby, it is possible to notify a user whether or not the current system performance is sufficient. Further, if the system performance is insufficient for the load applied to the system, it is possible to provide a user with recommendation as to how much the amount of resource added should be.

It should be noted that the present embodiment may be applied to the second to fifth embodiments.

In addition, according to the above-mentioned embodiments, the following invention is disclosed.

### APPENDIX 1

There is a capacity management support apparatus including:

storage unit that stores a type definition, which associates logs for resources with logs for loads corresponding to the logs for the resources, and a load definition which defines assumed load values as values of the loads that are assumed for a monitoring target system;

input unit that acquires input information which specifies association between the logs for the resources and the logs for the loads from among the type definition;

log acquisition unit that determines log types to be acquired on the basis of the input information and the type definition, and acquiring first log data which is obtained by extracting data on the determined log type from the logs held by the monitoring target system;

log distribution estimation unit that acquires second log data, which is data of correspondence relationships between the specific resources and the specific loads extracted from the first log data, on the basis of the type definition, estimating a distribution density function, which indicates actual distribution of load values and resource usages, on the basis of the second log data, selecting a range, which satisfies a specific condition, from the distribution density function, and acquiring third log data, which is data belonging to the range, in the second log data; and

resource usage rate prediction unit that calculates a prediction expression for resource usage rates on the basis of data of a certain threshold value or more in the third log data, and calculating predicted values of the resource usage rates, on the basis of the prediction expression and the load definition.

### APPENDIX 2

In the capacity management support apparatus according to Appendix 1,

the storage unit further stores a sorting definition that defines a condition and a method for sorting data pieces included in the third log data,

the capacity management support apparatus further includes log sorting unit that sorts the data pieces, which are included in the third log data, on the basis of the sorting definition so as to set the sorted data pieces as a plurality of fourth log data pieces, and

the resource usage rate prediction unit calculates the prediction expression for the resource usages, on the basis of the fourth log data.

### APPENDIX 3

In the capacity management support apparatus according to Appendix 2,

the storage unit further stores a correlation definition that associates main log types, which are log types determined on the basis of the input information and the load definition, with sub-log types which are log types correlated with the main log types, and defines patterns of the fourth log data on the basis of the resource usages of the main log types and the resource usages of the sub-log types,

the log acquisition unit further adds information on the sub-log types to the first log data, on the basis of the correlation definition,

the log distribution estimation unit estimates the distribution density function, on the basis of data of the resources and data of the loads relating to the main log types in the second log data, and

the log sorting unit further determines which of the patterns the plurality of the fourth log data pieces belongs to, on the basis of the correlation definition.

### APPENDIX 4

In the capacity management support apparatus according to any one of Appendices 1 to 3,

the storage unit further stores a safety factor definition that includes safety factors corresponding to types of the resources, and

the resource usage rate prediction unit corrects the predicted values and the prediction expression for the resource usage rates, on the basis of the safety factors.

### APPENDIX 5

In the capacity management support apparatus according to any one of Appendices 1 to 4,

the storage unit further stores a service level definition that includes a required value as the value of the load corresponding to a service level which is required for the monitoring target system, and

the capacity management support apparatus further includes service level determination unit that determines whether or not the monitoring target system satisfies the service level on the basis of the service level definition and the predicted values or the prediction expression calculated by the resource usage rate prediction unit.

### APPENDIX 6

In the capacity management support apparatus according to any one of Appendices 1 to 5,

the storage unit further stores a structure definition that stores an applied value, which indicates current performance of the monitoring target system, and an additional value which indicates a unit of an increase in the resources, and

the capacity management support apparatus further includes structure determination unit that determines whether or not it is necessary to enhance the performance of the monitoring target system on the basis of the structure definition and the predicted values and the prediction expression calculated by the resource usage rate prediction unit.

### APPENDIX 7

There is provided a capacity management method performed by a computer, including:

reading a type definition, which associates logs for resources with logs for loads corresponding to the logs for the resources, and a load definition, which defines assumed load values as values of the loads that are assumed for a monitoring target system, from storage unit;

acquiring input information which specifies association between the logs for the resources and the logs for the loads from among the type definition;

determining log types to be acquired on the basis of the input information and the type definition, and acquiring first log data which is obtained by extracting data on the determined log type from the logs held by the monitoring target system;

acquiring second log data, which is data of correspondence relationships between the specific resources and the specific loads extracted from the first log data, on the basis of the type definition, estimating a distribution density function, which indicates actual distribution of load values and resource usages, on the basis of the second log data, selecting a range, which satisfies a specific condition, from the distribution density function, and acquiring third log data, which is data belonging to the range, in the second log data; and

calculating a prediction expression for resource usage rates on the basis of data of a certain threshold value or more in the third log data, and calculating predicted values of the resource usage rates, on the basis of the prediction expression and the load definition.

### APPENDIX 8

There is provided a program for causing a computer to execute functions of:

storing a type definition, which associates logs for resources with logs for loads corresponding to the logs for the resources, and a load definition which defines assumed load values as values of the loads that are assumed for a monitoring target system;

acquiring input information which specifies association between the logs for the resources and the logs for the loads from among the type definition;

determining log types to be acquired on the basis of the input information and the type definition, and acquiring first log data which is obtained by extracting data on the determined log type from the logs held by the monitoring target system;

acquiring second log data, which is data of correspondence relationships between the specific resources and the specific loads extracted from the first log data, on the basis of the type definition, estimating a distribution density function, which indicates actual distribution of load values and resource usages, on the basis of the second log data, selecting a range, which satisfies a specific condition, from the distribution density function, and acquiring third log data, which is data belonging to the range, in the second log data; and

calculating a prediction expression for resource usage rates on the basis of data of a certain threshold value or more in the third log data, and calculating predicted values of the resource usage rates, on the basis of the prediction expression and the load definition.

### APPENDIX 9

In the capacity management method according to Appendix 7,

the storage unit further stores a sorting definition that defines a condition and a method for sorting data pieces included in the third log data, and

the computer

sorts the data pieces, which are included in the third log data, into a plurality of fourth log data pieces, on the basis of the sorting definition, and

calculates the prediction expression for the resource usages, on the basis of the fourth log data.

### APPENDIX 10

In the capacity management method according to Appendix 9,

the storage unit further stores a correlation definition that associates main log types, which are log types determined on the basis of the input information and the load definition, with sub-log types which are log types correlated with the main log types, and defines patterns of the fourth log data on the basis of the resource usages of the main log types and the resource usages of the sub-log types, and

the computer

further adds information on the sub-log types to the first log data, on the basis of the correlation definition,

estimates the distribution density function, on the basis of data of the resources and data of the loads relating to the main log types in the second log data, and

further determines which of the patterns the plurality of the fourth log data pieces belongs to, on the basis of the correlation definition.

### APPENDIX 11

In the capacity management method according to any one of Appendices 7, 9, and 10,

the storage unit further stores a safety factor definition that includes safety factors corresponding to types of the resources, and

the computer

corrects the predicted values and the prediction expression for the resource usage rates, on the basis of the safety factors.

### APPENDIX 12

In the capacity management method according to any one of Appendices 7 and 9 to 11,

the storage unit further stores a service level definition that includes a required value as the value of the load corresponding to a service level which is required for the monitoring target system, and

the computer

determines whether or not the monitoring target system satisfies the service level on the basis of the service level definition and the predicted values or the prediction expression calculated by the resource usage rate prediction unit.

### APPENDIX 13

In the capacity management method according to any one of Appendices 7, 9 to 12,

the storage unit further stores a structure definition that stores an applied value, which indicates current performance of the monitoring target system, and an additional value which indicates a unit of an increase in the resources, and

the computer

determines whether or not it is necessary to enhance the performance of the monitoring target system on the basis of the structure definition and the predicted values and the prediction expression calculated by the resource usage rate prediction unit.

### APPENDIX 14

In the program according to Appendix 8, the program further causes the computer to execute

further storing a sorting definition that defines a condition and a program for sorting data pieces included in the third log data,

sorting the data pieces, which are included in the third log data, into a plurality of fourth log data pieces, on the basis of the sorting definition, and

calculating a prediction expression for the resource usages, on the basis of the fourth log data.

### APPENDIX 15

In the program according to Appendix 14, the program further causes the computer to execute

further storing a correlation definition that associates main log types, which are log types determined on the basis of the input information and the load definition, with sub-log types which are log types correlated with the main log types, and defines patterns of the fourth log data on the basis of the resource usages of the main log types and the resource usages of the sub-log types,

further adding information on the sub-log types to the first log data, on the basis of the correlation definition,

estimating the distribution density function, on the basis of data of the resources and data of the loads relating to the main log types in the second log data, and

further determining which of the patterns the plurality of the fourth log data pieces belongs to, on the basis of the correlation definition.

### APPENDIX 16

In the program according to any one of Appendices 8, 14, and 15, the program further causes the computer to execute

further storing a safety factor definition that includes safety factors corresponding to types of the resources, and

correcting the predicted values and the prediction expression for the resource usage rates, on the basis of the safety factors.

### APPENDIX 17

In the program according to any one of Appendices 8 and 14 to 16, the program further causes the computer further to execute

further storing a service level definition that includes a required value as the value of the load corresponding to a service level which is required for the monitoring target system, and

determining whether or not the monitoring target system satisfies the service level on the basis of the service level definition and the predicted values or the prediction expression for the resource usage rates.

### APPENDIX 18

In the program according to any one of Appendices 8, 14 to 17, the program further causes the computer to execute

further storing a structure definition that stores an applied value, which indicates current performance of the monitoring target system, and an additional value which indicates a unit of an increase in the resources, and

determining whether or not it is necessary to enhance the performance of the monitoring target system on the basis of the structure definition and the predicted values and the prediction expression for the resource usage rates.

As described above, the embodiments of the present invention was described with reference to the drawings. However, the embodiments are just examples of the present invention, and may employ various configurations other than the above-mentioned configurations.

Further, in the description of each embodiment described above, the plurality of operations was sequentially described in the form of the flowchart. However, the order of the description does not limit the order of execution of the plurality of operations. Hence, in the case of carrying out each embodiment, the order of the plurality of operations may be changed in a range in which no trouble is caused on a content basis.

Furthermore, in each embodiment described above, the plurality of operations is not limited to executing the individual operations at different timings. For example, during execution of a certain operation, another operation may be executed, or the execution timings of a certain operation and another operation may be partially or fully overlapped with each other.

Moreover, in the description of each embodiment described above, a certain operation functions as a trigger of another operation. However, the description does not limit all the relationships between the certain operation and other operations. Hence, in the case of carrying out each embodiment, the relationships of the plurality of operations may be changed in a range in which no trouble is caused on a content basis. In addition, the detailed description of each operation of each component does not limit each operation of each component. Therefore, each specific operation of each component may be changed in a range in which no trouble is caused in functional, performance, and other characteristics when carrying out each embodiment.

This application claims the benefit of priority from Japanese Patent Application No. 2012-47305 filed on Mar. 2, 2012, and the content of which is incorporated herein by reference in its entirety.

1. A capacity management support apparatus comprising:
storage unit that stores a type definition, which associates logs for resources with logs for loads corresponding to the logs for the resources, and a load definition which defines assumed load values as values of the loads that are assumed, for a monitoring target system;
input unit that acquires input information which specifies association between the logs for the resources and the logs for the loads from among the type definition;
log acquisition unit that determines log types to be acquired on the basis of the input information and the type definition, and acquires first log data which is obtained by extracting data on the determined log type from the logs held by the monitoring target system;
log distribution estimation unit that acquires second log data, which is data of correspondence relationships between the specific resources and the specific loads extracted from the first log data, on the basis of the type definition, estimates a distribution density function, which indicates actual distribution of load values and resource usages, on the basis of the second log data, selects a range, which satisfies a specific condition, from the distribution density function, and acquires third log data, which is data belonging to the range, in the second log data; and
resource usage rate prediction unit that calculates a prediction expression for resource usage rates on the basis of data of a certain threshold value or more in the third log data, and calculates predicted values of the resource usage rates, on the basis of the prediction expression and the load definition.

2. The capacity management support apparatus according to claim 1,
wherein the storage unit further stores a sorting definition that defines a condition and a method for sorting data pieces included in the third log data,
the capacity management support apparatus further comprises log sorting unit that sorts the data pieces, which are included in the third log data, on the basis of the sorting definition so as to set the sorted data pieces as a plurality of fourth log data pieces, and
wherein the resource usage rate prediction unit calculates the prediction expression for the resource usages, on the basis of the fourth log data.

3. The capacity management support apparatus according to claim 2,
wherein the storage unit further stores a correlation definition that associates main log types, which are log types determined on the basis of the input information and the load definition, with sub-log types which are log types correlated with the main log types, and defines patterns of the fourth log data on the basis of the resource usages of the main log types and the resource usages of the sub-log types,
wherein the log acquisition unit further adds information on the sub-log types to the first log data, on the basis of the correlation definition,
wherein the log distribution estimation unit estimates the distribution density function, on the basis of data of the resources and data of the loads relating to the main log types in the second log data, and
wherein the log sorting unit further determines which of the patterns the plurality of the fourth log data pieces belongs to, on the basis of the correlation definition.

4. The capacity management support apparatus according to claim 1,
wherein the storage unit further stores a safety factor definition that includes safety factors corresponding to types of the resources, and
wherein the resource usage rate prediction unit corrects the predicted values and the prediction expression for the resource usage rates, on the basis of the safety factors.

5. The capacity management support apparatus according to claim 1,
wherein the storage unit further stores a service level definition that includes a required value as the value of the load corresponding to a service level which is required for the monitoring target system, and
the capacity management support apparatus further comprises service level determination unit that determines whether or not the monitoring target system satisfies the service level on the basis of the service level definition and the predicted values or the prediction expression calculated by the resource usage rate prediction unit.

6. The capacity management support apparatus according to claim 1,
wherein the storage unit further stores a structure definition that stores an applied value, which indicates current performance of the monitoring target system, and an additional value which indicates a unit of an increase in the resources, and
the capacity management support apparatus further comprises structure determination unit that determines whether or not it is necessary to enhance the performance of the monitoring target system on the basis of the structure definition and the predicted values and the prediction expression calculated by the resource usage rate prediction unit.

7. A capacity management method performed by a computer, comprising:
reading a type definition, which associates logs for resources with logs for loads corresponding to the logs for the resources, and a load definition, which defines assumed load values as values of the loads that are assumed for a monitoring target system, from storage unit;
acquiring input information which specifies association between the logs for the resources and the logs for the loads from among the type definition;
determining log types to be acquired on the basis of the input information and the type definition, and acquiring first log data which is obtained by extracting data on the determined log type from the logs held by the monitoring target system;
acquiring second log data, which is data of correspondence relationships between the specific resources and the specific loads extracted from the first log data, on the basis of the type definition, estimating a distribution density function, which indicates actual distribution of load values and resource usages, on the basis of the second log data, selecting a range, which satisfies a specific condition, from the distribution density function, and acquiring third log data, which is data belonging to the range, in the second log data; and
calculating a prediction expression for resource usage rates on the basis of data of a certain threshold value or more in the third log data, and calculating predicted values of the resource usage rates, on the basis of the prediction expression and the load definition.

8. A computer-readable recording medium storing a program for causing
a computer to execute functions of:
storing a type definition, which associates logs for resources with logs for loads corresponding to the logs for the resources, and a load definition which defines assumed load values as values of the loads that are assumed for a monitoring target system;
acquiring input information which specifies association between the logs for the resources and the logs for the loads from among the type definition;
determining log types to be acquired on the basis of the input information and the type definition, and acquiring first log data which is obtained by extracting data on the determined log type from the logs held by the monitoring target system;
acquiring second log data, which is data of correspondence relationships between the specific resources and the specific loads extracted from the first log data, on the basis of the type definition, estimating a distribution density function, which indicates actual distribution of load values and resource usages, on the basis of the second log data, selecting a range, which satisfies a specific condition, from the distribution density function, and acquiring third log data, which is data belonging to the range, in the second log data; and
calculating a prediction expression for resource usage rates on the basis of data of a certain threshold value or more in the third log data, and calculating predicted values of the resource usage rates, on the basis of the prediction expression and the load definition.
